(19) United States
(12) Patent Application Publication
(10) Pub. No.: US 2001/0010853 A1
(43) Pub. Date: Aug. 2, 2001

(54) Transponder lable having a protective coating

(75) Inventor: Andreas Schragle, Oberhaching (DE)

Correspondence Address: THE FIRM OF KARL F ROSS, 5676 RIVERDALE AVENUE, PO BOX 900, RIVERDALE (BRONX), NY, 10471-0900, US

(73) Assignee: smart-TEC GmbH & Co. KG

(21) Appl. No.: 09/745,509

(22) Filed: Dec. 22, 2000

(30) Foreign Application Priority Data
Dec. 27, 1999 (DE) 19963300.2

(51) Int. Cl. B32B 3/02

(52) U.S. Cl. 428/68

(57) ABSTRACT

The present invention relates to a transponder label having a protective coating and a protective coating for a transponder label. According to the present invention the protective coating comprises a flexible material that protects the transponder components against impact, tensile load and torsional stress. The flexible material preferably comprises a polyaddition product of two components, whereby the first component represents an organic molecule having at least two isocyanate groups, while the second component represents an organic molecule having at least two hydroxyl groups.

The present invention relates to a transponder label comprising a protective label and to a protective label for a transponder label.

Transponders are wireless communications, security or control units that receive incoming signals and react thereto. Transponders may be either passive or active. Passive transponders comprise a programmable, integrated circuit and an antenna. The passive transponder is used in combination with an active sensor that decodes and processes the data stored in the transponder. For this purpose, the active sensor transmits a signal (generally an RF signal) that provides the transponder with the energy necessary for re-transmission. Due to the simple setup, the transponder may be of minimal size. Nevertheless, a data exchange may occur at a distance of up to 2 meters.

Since, on the one hand, transponders are more frequently utilized in everyday applications, for example door openers, inventory or deposits, the electronic parts contained therein, on the other hand, are, however, sensitive to mechanical wear and tear and other influences, and transponders are coated with a protective layer or integrated into devices having a sturdy hull or housing. The protective coating is, however, inflexible and is made of plastic. A known example is the integration of transponders into credit cards.

Transponders are also utilized in labels. The utilization of standard coatings for transponder labels, however, has a number of disadvantages. For example, the known coatings do not provide sufficient protection against the influence of strong impact and tensile load. Such strain will cause the coating to break or the acting forces will be passed on to the sensitive electronic parts. In order to nevertheless ensure sufficient protection, the known protective coatings must be applied with a greater depth. This understandably results in inflexibility of the protective coating and therefore of the entire transponder label. For this reason, such protective coatings are only of limited use for stickers or sew-on labels.

It is therefore an object of the present invention to provide a transponder label having a protective coating and further to provide a protective coating for a transponder label, which does not have the disadvantages of the prior art transponder labels.

A transponder label having a protective coating comprising the features of the independent claims solves this object.

The inventive protective coating consists of a flexible material tat protects the transponder components against impact, tensile load and torsional stress. Coils and integrated circuits are very sensitive to mechanical strain and may easily be damaged or destroyed by such normally occurring mechanical strain. Inflexible protective coatings for transponders generally offer protection against outside influences such as moisture and UV-radiation. They may, however, break when a certain strain level is exceeded. Consequently, transponders having inflexible, or partially flexible protective coatings are only of limited use for certain applications. The protective coating according to the present invention, however, is flexible and, hence, its protection may only be offset by extreme conditions and intended destruction. The coating may be exposed to torsion and may resist strong impacts. Further, normal everyday tensile loads are not critical. Due to these mechanical characteristics, transponders may be utilized in a wide variety of new applications. The transponder can be used in labels, for example, which are then sewn into articles of clothing or clamped thereon. In addition, the transponder can be integrated into stickers that can then be attached to any surface, that is, on rough or slightly curved surfaces. In this way, transponder technology can be utilized simply by everyone, without technical foreknowledge being required and without having to consider attachment to or integration into devices.

As a preferred embodiment, the protective coating comprises polyurethane resin and the usual additives. A mixture ratio of 95% of a two-constituent polyurethane resin proves to be particularly advantageous, with the remainder corresponding to the aforementioned additives. All the additives standard in the prior art are considered as useable synthetic materials, in particular such as auxiliary or carrier materials, fillers, formless substances, dyes, as well as, for example, inorganic and/or organic pigments, thermal stabilizers, light fastness stabilizers, and polymerization initiators or their reaction products and residue and cross-linking molecules or their reaction products and residue.

The protective coating should contain a polyurethane component as a preferred embodiment. This is understood to be a polyaddition product of two educt components, where the first educt component represents an organic molecule having at least two isocyanate groups, while the second educt component represents an organic molecule having at least two hydroxyl groups. Preferably, a material quantity ratio for both educt components of 100 parts of the first educt component and 55 parts of the second educt component are used. In any case, according to the present invention both edict components should preferably be presented corresponding to a material quantity ratio which enables development of a polyurethane during a polyaddition reaction running exactly stoichiometrically avoiding secondary reactions or formation of interfering residues, that is, on the basis of a monomer conversion as complete as possible. These details should, however, not limit the scope of protection of the invention, rather they are to be understood as starting points. Deviations from the existing ratio of educt components, which are disclosed to the expert on the basis of his general knowledge and ability, for example with respect to the monomer components selected in the individual case, should also fall under the protective scope of the present invention.

The protective coating is manufactured particularly preferably without tile addition of softeners. The advantage here is that the problems normally associated with the use of softeners according to the prior art can now b avoided. Such problems are associated in particular with the fact that usual softener molecules tend to diffuse gradually over time from the offset polymer mass, which on tie one hand causes creeping ageing of the corresponding polymer material, which finally may even become unusable, and on the other hand results in loading or contamination of the environment of such materials by the aforementioned softeners. The applicant has discovered that a novel transponder protective coating may be manufactured, which on the one hand is highly flexible and on the other hand is remarkably impact-resistant, even if the use of softeners standard in the prior art in such materials is dispensed with.

A coating thickness of die protective layer of ca. 2.0 mm has proven advantageous. Hardness tests have shown a particularly high load-carrying capacity of the protective coating with common, though also extreme, mechanical loads with a Shore A hardness of 75 to 79.

Further to this, the protective coating preferably comprises a transparent material for the combination of the transponder label with visibly recognizable inscriptions or markings. This property is given for the above-described polyurethane resins.

In order to attach the transponder label easily to other materials such as textiles, designs or wood, the transponder label has overlapping coating at the edges. The overlapping edge can be attached by sewing, riveting, fastening or clamping to the material, without the transponder being damaged, or without adhesive having to be applied to the back of the transponder.

To withstand all normal loads, the present protective coating is also crack-proof and scratch-resistant. Also, it is resistant to UV rays, humidity, oils, petrol and detergents.

On the basis of the above-described structure, the present protective coating can be used in any type of transponder. In principle, the protective coating can also be used generally in integrated circuit boards.

Detailed embodiments of the invention will now be explained with reference to the diagrams:

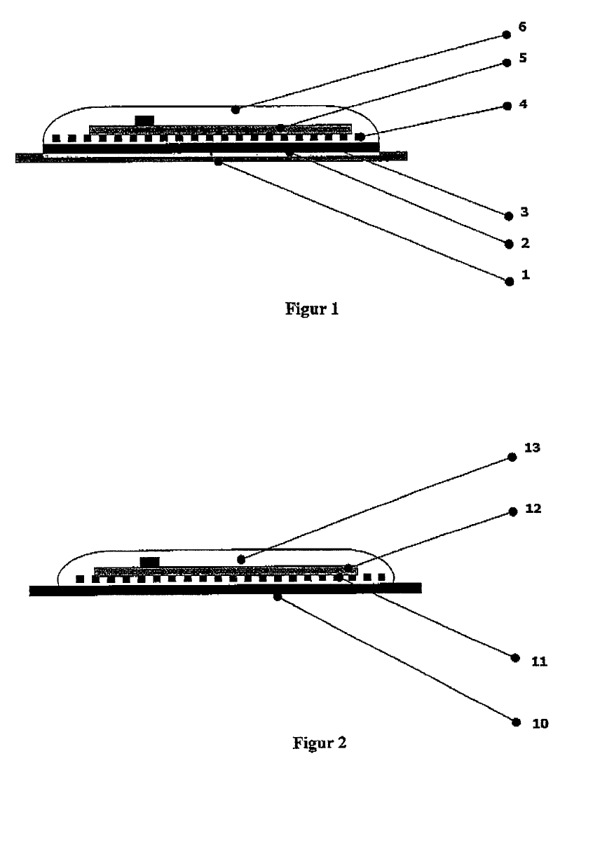

FIG. 1 illustrates a transponder label that is coated with a flexible, transparent polyurethane resin. According to FIG. 1 the transponder label exhibits (in upwards order) carrier paper (1), a background-specific special adhesive layer (2), PVC or PET film (3), optional printing colors (4), chip and coil (5) as well as a protective coating of polyurethane resin (6). The basic material can correspondingly be a self-adhesive polyester film.

FIG. 2 illustrates a transponder label for applying to materials such as textiles, designs or wood. The structure comprises (in upwards order) a special synthetic film (10), printing colors (11), the chip complete with coil (12) and a protective coating of polyurethane resin (13). Here, the inlay is cast homogeneously into an extremely tear-resistant protective coating. The overlapping layer can then be sewn on or fastened, for example.

1. A transponder label having a protective coating, characterized in that the protective coating comprises a flexible material that protects the transponder components against impact, tensile load and torsional stress.

2. Transponder label as claimed in claim 1, characterized in that the flexible material comprises a polyaddition product of two components, whereby the first component represents an organic molecule having at least two isocyanate groups, while the second component represents an organic molecule having at least two hydroxyl groups.

3. Transponder label as claimed in claim 2, characterized in that the aforementioned polyaddition product corresponds to a proportional quantity of 95% of the flexible material.

4. Transponder label as claimed in claim 2, characterized in that 100 parts of the first component and 55 parts of the second component have been used as a ratio of both components.

5. Transponder label as claimed in claim 2, characterized in that the flexible material contains no softeners.

6. Transponder label as claim in claim 1, characterized in that the Shore A hardness of the flexible material is 75 to 79.

7. Transponder label as claimed in claim 2, characterized in that the flexible material is transparent.

8. Transponder label as claimed in claim 1, characterized in that the protective coating projects over the edges of the transponder for fastening purposes.

9. Transponder label as claimed in claim 2, characterized in that the protective coating is crack-proof and scratch-resistant and is resistant to UV rays, humidity, oils, petrol and detergents.

10. A protective coating for a transponder label, characterized in that the protective coating comprises a flexible material that protects the transponder components against impact, tensile load and torsional stress.

11. Protective coating as claimed in claim 10, characterized in that the flexible material comprises a polyaddition product of two components, whereby the first component represents an organic molecule having at least two isocyanate groups, while the second component represents an organic molecule having at least two hydroxyl groups.

12. Protective coating as claimed in claim 11, characterized in that the aforementioned polyaddition product corresponds to a proportional quantity of 95% of the flexible material.

13. Protective coating as claimed in either of claim 11, characterized in that 100 parts of the first component and 55 parts of the second component have been used as a ratio of both components.

14. Protective coating as claimed in claim 11, characterized in that the flexible material contains no softeners.

15. Protective coating as claimed in claim 11, characterized in that the Shore A hardness of the flexible material is 75 to 79.

16. Protective coating as claimed in claim 11, characterized in that the flexible material is transparent.

17. Protective coating as claimed in claim 10, characterized in that the protective coating projects over the edges of the transponder for fastening purposes.

18. Protective coating as claimed in claim 11, characterized in that the protective coating is crack-proof and scratch-resistant and is resistant to UV rays, Humidity, oils, petrol and detergents.
